(19) United States
(12) Patent Application Publication
(10) Pub. No.: US 2018/0013563 A1
(43) Pub. Date: Jan. 11, 2018

(54) METHOD AND DEVICE FOR PROVIDING A TRUSTED ENVIRONMENT FOR EXECUTING AN ANALOGUE-DIGITAL SIGNATURE

(71) Applicant: OBSCHESTVO S OGRANICHENNOJ OTVETSTVENNOSTYU "LABORATORIA ELANDIS", Syktyvkar (RU)

(72) Inventor: Dmitry Aleksandrovich GERTNER, Syktyvkar (RU)

(21) Appl. No.: 15/545,044

(22) PCT Filed: Dec. 16, 2015
(86) PCT No.: PCT/RU2015/000887

§ 371 Date: Jul. 20, 2017

(30) Foreign Application Priority Data
Jan. 20, 2015 (RU) 2015101605

(51) Int. Cl. H04L 9/32; G06F 3/0354; H04L 9/14; H04L 9/30; G06K 9/00; G06F 3/038; H04N 5/232; G06F 3/0346

(52) U.S. Cl. CPC H04L 9/3226; G06K 9/00463; G06F 3/03545; G06F 3/038; G06K 9/00181; G06K 9/00483; H04L 9/14; H04L 9/30; G06K 9/00174; G06K 9/00604; G06K 2209/27; G06F 2203/0384; G06F 3/0346; H04N 5/232

(57) ABSTRACT

The invention relates to the field of providing a trusted environment for executing an analogue-digital signature. The claimed document-signing device in the form of a stylus includes a protective compartment, in which the following are disposed: a microcontroller with a programme code; a memory with a secret digital signature key; and additionally inertial sensors, which are connected to the microcontroller; a lens; and a camera, which is also connected to the microcontroller. A wireless interface is used in order to communicate with a computer. The inertial sensors serve to verify the handwritten signature of the user, while the lens and camera serve to carry out a comparison with the text of an electronic document uploaded via the wireless interface. In this way it is ensured that verified information enters the trusted environment of the stylus.

The present application is a National Phase Entry of International Patent Application no. PCT/RU2015/000887, filed on Dec. 16, 2015, entitled “METHOD AND DEVICE FOR PROVIDING A TRUSTED ENVIRONMENT FOR EXECUTING AN ANALOGUE-DIGITAL SIGNATURE”. This application is incorporated by reference herein in its entirety.

The invention relates to the electronic industry, namely, to paperless technologies for document management and can be used to transform the enterprise's primary documentation into the electronic form.

There are known electronic digital signature (EDS) algorithms that allow signing electronic documents with an electronic digital signature using secret user keys and verifying the authenticity of electronic digital signatures for public keys. The ownership of a public key to a particular user is verified by a digital signature of the trust center in the form of a digital certificate. For each user, a pair of unique keys is generated—the secret and public keys of the electronic digital signature. The user must keep his secret key in secret and use it when signing an electronic document.

The disadvantage of an electronic digital signature is the difficulty of creating trusted environment when signing electronic documents, especially when it comes to information containing legal facts. The trusted environment must ensure that the creation of an electronic digital signature in an electronic document is carried out in a trusted system, including hardware and software. To do this, you need to use a certified computer and software, with the help of which it is supposed to create an electronic digital signature. In doing so, it is not allowed to connect the computer to non-certified resources in the public network and run non-certified software on the computer, or give the computer to other people. Violation of these conditions creates potential threats:
unauthorized access to the cryptographic capabilities of the token/smart card with unrecoverable keys using spyware allows to conduct an attack using remote client computer tools, attack using a remote connection to a USB-port (USB-over-IP);
substitution of the document when it needs to be signed in a token with non-recoverable keys. The attack is possible with the use of spyware and/or due to errors in software implementation. The user sees one data on the monitor screen, and another one is sent to the signature.

In fact, you can only use a certified computer to sign electronic documents. Moreover, the user can sign electronic documents only on his own certified computer. All this creates serious problems for the wide use of electronic digital signatures.

The closest analogue is the invention “the way of signing documents by an electronic analog-digital signature and its realizing device”—patent of the Russian Federation No. 3398334, which allows signing documents by an electronic analog-digital signature, without preliminary generating users' personal electronic digital signatures. Identification of the user who signs such an electronic document is carried out using the user's biometric data, which becomes an integral part only of this electronic document and that cannot be used in another electronic document of the same format.

The disadvantage of this method and the device is the lack of sufficient reliability, which results in the fact that if an electronic document is entered into a device with a computer on which software can be pre-installed, commonly referred to as hacking, that is capable to replace an electronic document displayed on the monitor screen with another electronic document entered into the device for signing it. That creates a potential vulnerability, which can result in that the user, contrary to his will, signs another electronic document than what he sees on the monitor screen. Therefore, in this analogue, documents for signing are entered not from the computer, but from a printed document and additional devices, such as a barcode, a scanner or a digital camera, which is inconvenient in use and the necessity of preliminary printing of electronic documents.

The object of the present invention is to provide the way which guarantees trusted environment for an analog-digital signature performance and its realizing device that will eliminate this vulnerability and allow securely entering of electronic documents directly from any computer into the signature device.

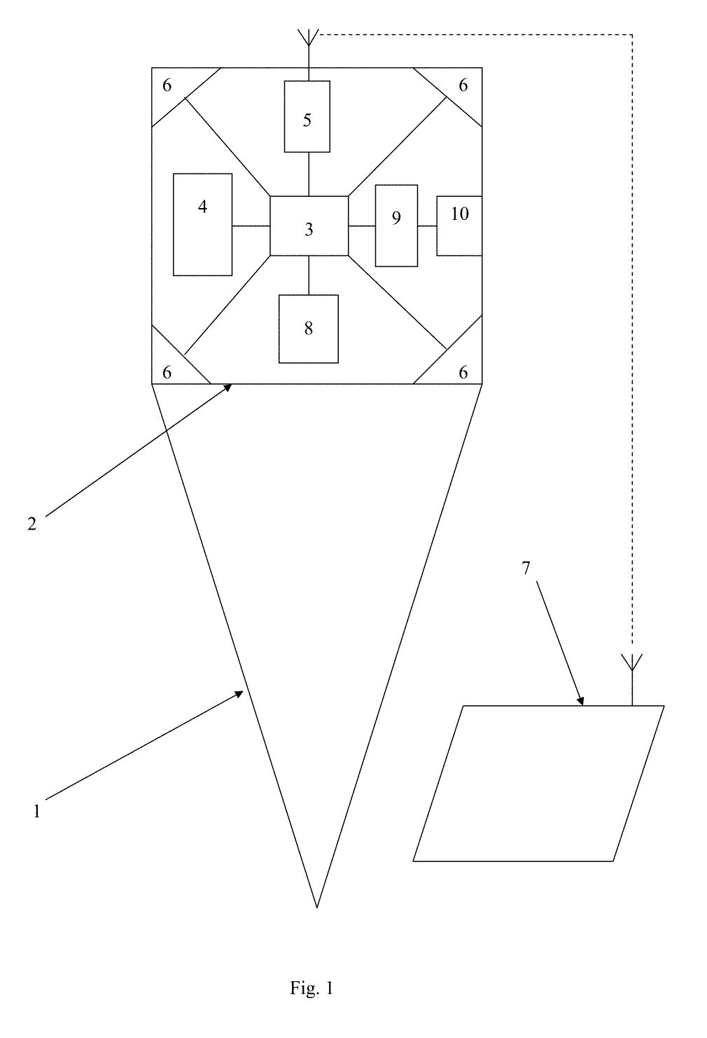

This task is achieved by the fact that the device for signing documents with an electronic analog-digital signature in the form of a stylus 1 (FIG. 1) for entering a handwritten signature consists of a protected compartment 2 in which there is a microcontroller 3 and associated memory 4. In the microcontroller 3 there is a program code for data processing and cryptographic operations, in particular algorithms for calculating the checksum and electronic digital signature. Memory 4 contains a secret digital signature key. The public key and, if necessary, the digital signature certificate may be positioned on external media. In addition, the stylus 1 comprises a transceiver 5 for wireless communication with an external computer. The transceiver 5 is connected to the microcontroller 3. The protected compartment 2 contains the tamper detectors 6 associated with the microcontroller 3 and the memory 4. In the case of damage of the protected compartment 2, the secret key in the memory 3 is erased. The microcontroller 3 is associated with the transceiver 5 for wireless communication with an external computer and processes the data and outputs the processed information through the transceiver 5 to the computer 7. According to the invention, the device is characterized by fact that into the protected compartment 2, inertial sensors 8 for recording the inertial characteristics of the stylus, and consequently the handwritten signature are placed. The inertial sensors 8 are connected to the microcontroller 3. As an inertial sensor, an accelerometer, a gyroscope and a magnetometer made using a micromechanical technology can be used. These miniature sensors are able to give the necessary information about the stylus movement—acceleration, speed, course and angles of inclination.

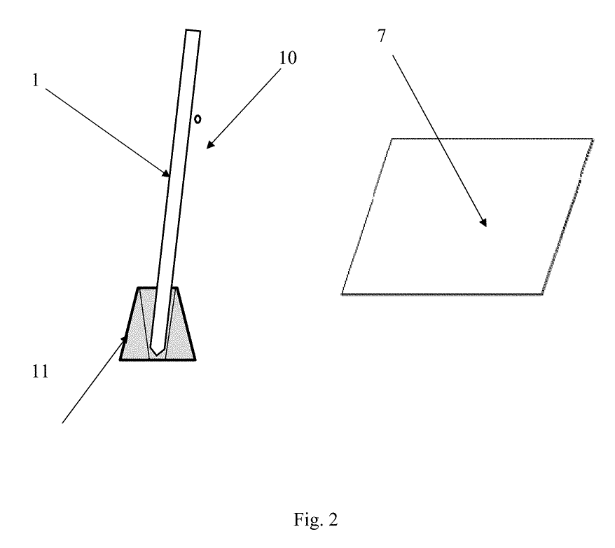

More over camera 9 with an objective 10 is placed in the protected compartment 2. The lens 10 is led out through the transparent portion of the protected compartment 2 for optical input of information from the computer screen 7. And the camera 9 is connected to the microcontroller 3. As for the camera, a photodiode CCD (charge-coupled device) or CMOS (complementary metal-oxide semiconductor) matrix, and as for a lens you can use a miniature lens type pinhole. In order that the lens is able to cover the screen of the computer, it is placed on the back of the stylus on the side. Additionally, the user can use the stand 11 (FIG. 2) for the stylus 1 to provide qualitative conditions for the operation of the camera 9.

The method of providing trusted environment for performing the analog-digital signature of the first variant works as follows. The user sees an electronic document on the monitor screen of an external computer 7. It is verified that a signature device is connected to the computer 7 via a wireless link. The user has the stylus 1 so that the screen of the computer 7 is in view of the lens 10 located on the back of the stylus 1. For this the user can use the stand 11. Then that the document is in the field of view of the lens 10, the user will be able to see on the screen in the form of selection of the electronic document fragments that were shot by the camera 9. The selection is possible as a color change or shade of the text, and its background. The control of the camera 9 and the lens 10 and for taking an image from the screen of the computer 7 is made by a program outputting the image of the electronic document to the computer screen 7. This program interacts with the microcontroller 3, the camera 9 and the objective 10 through the wireless transceiver 5. The program captures which text fragments of the electronic document and at what time it was displayed on the computer screen 7 and transmits this information through the wireless transceiver 5 to the microcontroller 3. If a fragment of the electronic document that has not yet been shot by the camera 9, the program instructs the microcontroller 3 to take another picture, and the microcontroller 3 sends camera 9 a command to take a picture. The camera 9 receives the next shot of the electronic document and transmits it to the microcontroller 3. In the microcontroller 3, by means of the program code, an electronic document received through the transceiver 5 with the image received from the camera 7 is compared. For this, it is determined whether the text in the received image frames corresponds to the digitized text of the electronic document. Since the text in the resulting picture area for the microcontroller is an image, then for the comparison with the digitized text of the electronic document, the picture needs to be recognized, which is quite a challenge for the microcontroller 3. First, it is necessary to recognize the screen borders on the image, and then the picture inside the screen borders. The first task can be transferred to an external computer with a more powerful processor. And the second task of recognizing the picture inside the screen borders should be performed exactly in the microcontroller 3, i.e. in trusted environment. Therefore, to simplify and speed up the recognizing of a picture, a well-known text of an electronic document is superimposed over the picture. Moreover, the text symbols are superimposed exactly in those places on the picture, where they are in the field of the document, since this information is also transmitted by the program from computer 7 to the microcontroller 3. Thus, the recognition task goes to the following point: is the object in the picture similar to certain coordinates of the location on a well-known symbol. And if it is similar, then with what part of the error. The error threshold is specified in advance. If the error is less than the specified threshold, then the object in the picture is considered to correspond to the symbol with which it was compared. The microcontroller 3 informs the program in computer 7 which fragments of the text have successfully passed the matching procedure and the program additionally allocates these fragments of text in the electronic document when they are displayed on the screen. Thus, while reading the user can visually verify that the electronic document has been successfully uploaded to the trusted environment.

After the electronic document has been loaded into the trusted environment, the user can sign it using the stylus 1 on the computer screen 7. It is assumed that a screen with pen input function is used. It can be a tablet computer with a touchscreen screen. In this case, it is possible that the user will enter his handwritten signature on some other device intended for this purpose. In any case, the handwritten input device must receive a digitized handwritten signature video and send it through the wireless transceiver to the transceiver 5 of the stylus 1, from where it will be placed in the trusted environment in the protective compartment 2, namely to the microcontroller 3. Simultaneously with this the inertial sensors 8 also supply data to microcontroller 3 with information about the movement of the stylus during the input of the handwritten signature. These data are supplied by sensors such as an accelerometer, a gyroscope and a magnetometer made using micromechanical technology. With a certain amount of error in the data from inertial sensors and the video of the handwritten signature correlate with each other. This interrelation, with a predetermined error, using the program code in the microcontroller 3 is used to determine whether the uploaded digital signature of the data from the inertial sensors. To obtain comparisons, a common timeline is used, which simplifies the comparison analysis.

In the case of a positive outcome of both comparisons trusted environment is considered secured. Then cryptographic operations of imposing a digital signature on the digitized video of a handwritten signature and a digitized electronic document using the secret key of the digital signature from memory in the microcontroller are made.

The second variant for providing trusted environment for performing an analog-digital signature works as follows. Before signing electronic documents the user must first upload a sample of his handwritten signature into the memory 4 in the stylus 1. To do this, the user must make a signature several times using the stylus 1 on the screen with the pen input and select the best variant of the signature as a sample. Simultaneously with this in the stylus 1 the inertial sensors 8 form and transfer to the microcontroller 3 and further to the memory 4 inertial characteristics corresponding to the received handwritten signatures of the user. In this case, the software of the external computer 7 which interacts with the pen input screen will transmit to the microcontroller 3 of the stylus 1 via the wireless transceiver 5 the digitized handwritten signature of the user selected by him as a sample. The sample of the handwritten signature is stored in memory 4. And the inertial characteristics with the help of the program code in the microcontroller 3 are transferred to the biometric digital code as a sample of the inertial characteristics and also stored in the memory 4. The interrelation between the obtained samples is established. Moreover the user can add additional information to these samples, for example, the name and surname of the user to whom these samples belong.

If several users will use stylus 1, then several samples of signatures and their corresponding inertial characteristics can be stored in it.

After this preliminary stage the user can sign electronic documents using this stylus.

Preliminarily, just as in the first variant, an electronic document is input to the trusted environment of the stylus 1 through the wireless transceiver 5 and at the same time through the camera 9 and the lens 10.

After the electronic document is uploaded into the trusted environment, the user can sign it using the stylus 1. Any surface can be used for this. And the stylus 1 can be combined with a pen and accordingly the user can sign, for example, on a piece of paper, which after that can be immediately destroyed. At the moment when the user signs his handwritten signature, the inertial sensors 6 receive data on the stylus movement—the inertial characteristics of the signature are transferred to the microcontroller 3. In the microcontroller 3, using the program code, the data from inertial sensors are compared with samples of inertial characteristics recorded in memory 4 taking into account a predetermined error. In the case of a coincidence with any sample—the necessary sample of the handwritten signature corresponding to the given model of inertial characteristics is found in the memory.

In case of a positive result trusted environment is considered secured. Then cryptographic operations of digital signature imposition in the microcontroller using a secret digital signature key from memory 4 to a digitized electronic document and a corresponding handwritten signature sample is performed.

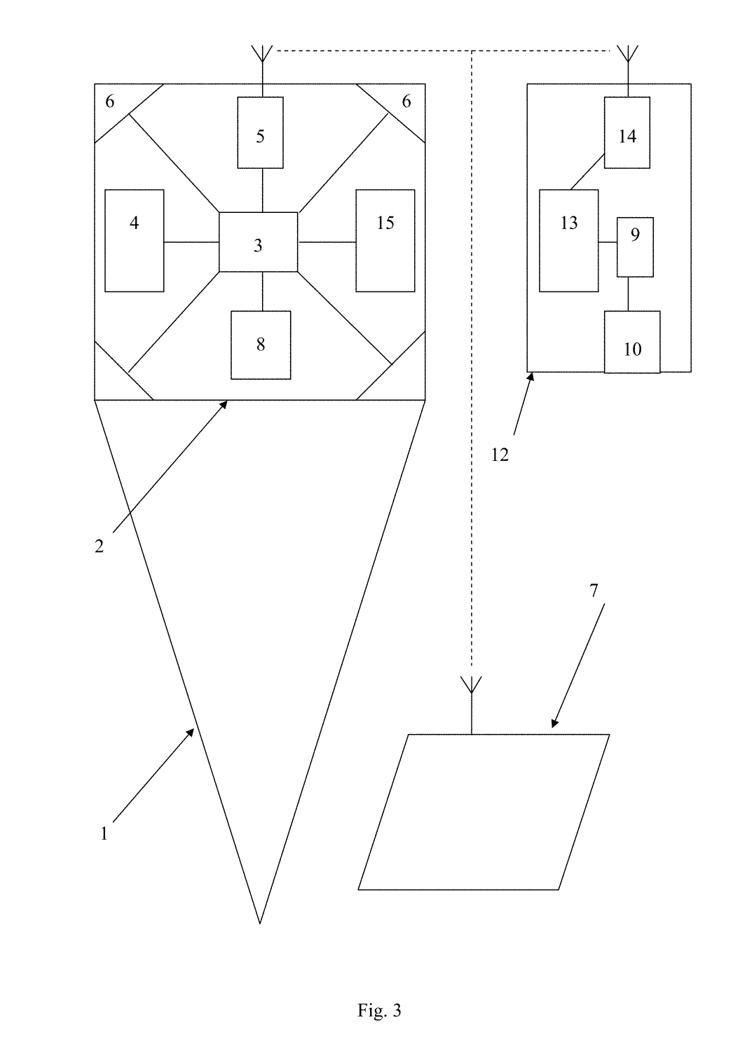

In particular cases, for the user's convenience, the invention may be implemented using an additional protected compartment 12 (FIG. 3) that is physically separated from the stylus 1. In this case, the camera 9 and the objective 10 are placed in this secure compartment 12. A cryptographic module 13 with unique secret and public keys and a transceiver 14 for wireless communication are placed there as well. In this case, a similar cryptographic module 15 with unique secret and public keys is also included in the main secure compartment 2 to provide common trust environment between both protected compartments via interaction using the cryptographic modules and keys.

An additional protected compartment 12 can be made in the form of a spectacle headpiece or as part of a spectacle frame, with the lens placed on the outer front side of the frame, so that when the user is working at the computer with these glasses—the lens covers the computer screen 7. This option is convenient by the fact that you do not need to install the stylus 1 in front of the screen, pointing with the lens. If the user has glasses, then it is enough to wear glasses with the protected compartment 12. And then, while reading the electronic document, the lens 10 will also be directed towards the screen.

And in cases where there are increased requirements for protecting the confidentiality of electronic documents in the additional protected compartment 12 the module for scanning the user's retina can be installed. This module comprises a microcontroller with software, a memory for storing retina samples of one or more users, and at least one additional camera and lens associated with the microcontroller, the lens is located on the inside of the frame with the ability to scan the retina of the user's eyes when the user wears glasses. The photographed user's retina in this case can serve both for user authentication with access rights and for additional confirmation of the authorship of the signature. In the latter case, the picture with the user's retina is attached to the signed electronic document and the digitized handwritten signature has a common digital signature.

In general, the invention can be implemented in practice using known technologies and cryptographic algorithms, in particular digital signature algorithms and asymmetric encryption using elliptical functions. While the present invention has been described with reference to certain embodiments, specialists may propose other similar embodiments without departing from the spirit and scope of the invention. Therefore, the invention should be evaluated in the terms of the subject of the invention.

1.-14. (canceled)

15. A method of providing a trusted environment for electronic documents, the trusted environment being based on an analog-digital signature, the method executable by a signing device that includes:
a secure compartment comprising
a microcontroller storing a computer-executable program code for processing data and performing cryptographic operations, and
a memory operatively connected to the microcontroller, the memory storing a private digital signature key,
the secure compartment being configured to erase the private digital signature key in case of crippling of a body of the secure compartment;
a wireless transceiver operatively connected to the microcontroller, the wireless transceiver configured to wirelessly communicate with a remote computer;
the secure compartment housing:
inertial sensors, the inertial sensors being operatively coupled to the microcontroller and configured to record dynamic characteristics of a handwritten signature; and
a camera operatively coupled to the microcontroller and having a lens for receiving an optical data input from a computer screen; and
a stylus;
the method comprising:
receiving, by the microcontroller from the camera, an image frame data having one or more images of an electronic document and an indication of a time of obtaining the image frame data,
receiving, by the microcontroller, via the wireless transceiver from the remote computer, the electronic document, the electronic document having been digitized, and information regarding which portions of the electronic document and at what time have been displayed on the computer screen;
executing a first comparing, at the microcontroller, of the electronic document with the image frame data to determine whether content of the image frame data and digitized text of the electronic document match;
receiving, by the microcontroller from the inertial sensors, a stylus movement data;
receiving, by the microcontroller from the remote computer, a digitized handwritten signature video of the user's applying user's handwritten signature;
executing a second comparing, at the microcontroller, of the digitized handwritten signature video with the stylus movement data to determine whether the stylus movement data from the inertial sensors matches the digitized handwritten signature video,
in response to the first comparing and the second comparing both rendering a positive outcome, determining that the trusted environment is secured;
performing, by the microcontroller, at least one cryptographic operation of applying a digital signature on the digital handwritten signature video and the digitized electronic document using the private digital signature key, the performing rendering a digital signature; and
transmitting the digital signature to the remote computer.

16. The method of claim 15, wherein the second comparing is made by comparing of the stylus movement data with the digitized handwritten signature video on a common timeline.

17. The method of claim 15, wherein the second comparing renders the positive outcome if the stylus movement data and the digitized handwritten signature video match with an error being within a predetermined error margin.

18. The method according to claim 15, wherein the first comparing is performed by overlaying the digitized text of the electronic document over image frame data, taking into account respective locations in the document image window of the digitized text of the electronic document and of a text in the image frame data.

19. The method according to claim 15, wherein requesting to display the image of the electronic document on the computer screen and controlling of the camera and the lens for capturing the image at the computer screen is made by the same computer-executable program code.

20. The method according to claim 19, further comprising, at the microcontroller, identifying portions of the text of the electronic document that were captured by the camera and further highlighting those portions of the text that have successfully passed the matching procedure.

21. A method of providing a trusted environment for electronic documents, the trusted environment being based on an analog-digital signature, the method executable by a signing device that includes:
a secure compartment comprising
a microcontroller storing a computer-executable program code for processing data and performing cryptographic operations, and
a memory operatively connected to the microcontroller, the memory storing a private digital signature key,
the secure compartment being configured to erase the private digital signature key in case of crippling of a body of the secure compartment;
a wireless transceiver operatively connected to the microcontroller, the wireless transceiver configured to wirelessly communicate with a remote computer;
the secure compartment housing:
o inertial sensors, the inertial sensors being operatively coupled to the microcontroller and the memory and configured to record dynamic characteristics of a handwritten signature, and
a camera operatively coupled to the microcontroller and having a lens for receiving an optical data input from a computer screen; and
a stylus;
the method comprising:
recording in the memory (i) a sample of handwritten signature, the sample received from the stylus and (ii) a sample of dynamic characteristics, the dynamic characteristics corresponding to the sample of the handwritten signature, the sample of dynamic characteristics received from the inertial sensors;
receiving, by the microcontroller from the camera, an image frame data having one or more images of an electronic document and an indication of a time of obtaining the image frame data,
receiving, by the microcontroller, via the wireless transceiver from the remote computer, the electronic document, the electronic document having been digitized, and information regarding which portions of the electronic document and at what time have been displayed on the computer screen;
executing a first comparing, at the microcontroller, of the electronic document with the image frame data to determine whether content of the image frame data and digitized text of the electronic document match;
receiving, by the microcontroller from the inertial sensors, a stylus movement data;
executing a second comparing, at the microcontroller, of the stylus movement data with at least one sample of dynamic characteristics recorded earlier in the memory, taking into account a predetermined error margin, and
in case of a match, within the predetermined error margin, between the stylus movement data and a given stored sample of dynamic characteristics, retrieving a corresponding given stored sample of handwritten signature;
in response to the first comparing and the second comparing both rendering a positive outcome, determining that the trusted environment is secured;
performing, at the microcontroller, at least one cryptographic operation of applying a digital signature on the corresponding given stored sample of handwritten signature and the digitized electronic document using the private digital signature key;
and
transmitting the digital signature and the matching sample of handwritten signature to the remote computer.

22. The method according to claim 21, wherein the first comparing is performed by overlaying the digitized text of the electronic document over image frame data, taking into account respective locations in the document image window of the digitized text of the electronic document and of a text in the image frame data.

23. The method according to claim 21, wherein requesting to display the image of the electronic document on the computer screen and controlling of the camera and the lens for capturing the image at the computer screen is made by the same computer-executable program code.

24. The method according to claim 23, further comprising, at the microcontroller, identifying portions of the text of the electronic document that were captured by the camera and further highlighting those portions of the text that have successfully passed the matching procedure.

25. A device for providing a trusted environment for electronic documents, the trusted environment being based on an analog-digital signature, the device comprising:
a secure compartment comprising
a microcontroller storing an computer-executable program code for processing data and performing cryptographic operations, and
a memory operatively connected to the microcontroller, the memory storing a private digital signature key,
the secure compartment being configured to erase the private digital signature key in case of crippling of a body of the secure compartment;
a wireless transceiver operatively connected to the microcontroller, the wireless transceiver configured to wirelessly communicate with a remote computer;
the secure compartment housing:
inertial sensors, the inertial sensors operatively coupled to the microcontroller and configured to record dynamic characteristics of a handwritten signature; and
a camera operatively coupled to the microcontroller and having a lens for receiving an optical data input from a computer screen, the lens being directed outside through a transparent portion of the protected compartment for the optical input of the information from the computer screen;
wherein the microcontroller is configured
to execute a first comparison of an electronic document received wirelessly with an image fame data received from the camera to determine whether a text in the received image frame data matches a digitized text of the electronic document;
to execute a second comparison of a handwritten signature video received wirelessly with a stylus movement data, the stylus movement data transmitted by the inertial sensors, to determine whether the stylus movement data matches the handwritten signature video.

26. The device according to claim 25, wherein at least one of the inertial sensors comprises one of: an accelerometer, a gyroscope and a micromechanical magnetometer.

27. The device according to claim 25, wherein the camera is a photodiode array and the lens is a pinhole lens.

28. The device according to claim 25, further comprising
an additional secure compartment being physically separated from the body of the secure compartment, the additional secure compartment housing the camera, the lens, an additional cryptographic module with unique private and public keys, and an additional wireless transceiver for wireless communication, and
the secure compartment further comprising a main cryptographic module with unique private and public keys to provide a common trusted environment through interaction between the main and the additional cryptographic modules.

29. The device according to claim 28, wherein the additional protected compartment is a spectacle attachment.

30. The device according to claim 28, wherein the additional protected compartment is located at a spectacle frame and the lens is located on the outer side of the spectacle frame.

31. The device according to claim 30, further comprising an additional security module having a user's eye retina scan module.
